(19) United States
(12) Patent Application Publication
(10) Pub. No.: US 2009/0140170 A1
(43) Pub. Date: Jun. 4, 2009

(54) MICROFLUIDIC SYSTEMS, DEVICES AND METHODS FOR REDUCING BACKGROUND AUTOFLUORESCENCE AND THE EFFECTS THEREOF

(75) Inventors: Joshua T. Nevill, El Cerrito, CA (US); Eric T. Espenhahn, Cary, NC (US); Daniel M. Hartmann, East Lansing, MI (US); Gregory A. Votaw, Durham, NC (US); Hugh C. Crenshaw, Durham, NC (US)

Correspondence Address: EKSIGENT TECHNOLOGIES, LLC;c/o SHELDON MAK ROSE & ANDERSON, 100 East Corson Street, Third Floor, PASADENA, CA, 91103-3842, US

(73) Assignee: EKSIGENT TECHNOLOGIES, LLC, Dublin, CA (US)

(21) Appl. No.: 11/719,526

(22) PCT Filed: Aug. 10, 2006
(86) PCT No.: PCT/US06/31158

§ 371 Date: May 16, 2007

Related U.S. Application Data
(60) Provisional application No. 60/707,386, filed on Aug. 11, 2005.

(51) Int. Cl. H05B 33/00; G01J 1/58

(52) U.S. Cl. 250/484.4; 250/459.1; 250/458.1

(57) ABSTRACT

According to one embodiment, a microfluidic system and method is disclosed for reducing autofluorescence. The microfluidic system can include a light source for generating an excitation light. The microfluidic system can also include a microscope having an objective for focusing the excitation light on a fluid inside a microfluidic channel of a microfluidic chip. Further, the microfluidic system can include a detector for rejecting out-of-focus light emitted from the microfluidic chip.

### CROSS-REFERENCE TO RELATED APPLICATIONS

This application claims the benefit of U.S. Patent Application Ser. No. 60/707,386, filed Aug. 11, 2005, the disclosure of which is incorporated herein by reference in its entirety. The disclosures of the following U.S. Provisional Applications, commonly owned and simultaneously filed Aug. 11, 2005, are all incorporated by reference in their entirety: U.S. Provisional Application entitled MICROFLUIDIC APPARATUS AND METHOD FOR SAMPLE PREPARATION AND ANALYSIS, U.S. Provisional Application No. 60/707,373 (Attorney Docket No. 447/99/2/1); U.S. Provisional Application entitled APPARATUS AND METHOD FOR HANDLING FLUIDS AT NANO-SCALE RATES, U.S. Provisional Application No. 60/707,421 (Attorney Docket No. 447/99/2/2); U.S. Provisional Application entitled MICROFLUIDIC BASED APPARATUS AND METHOD FOR THERMAL REGULATION AND NOISE REDUCTION, U.S. Provisional Application No. 60/707,330 (Attorney Docket No. 447/99/2/3); U.S. Provisional Application entitled MICROFLUIDIC METHODS AND APPARATUSES FOR FLUID MIXING AND VALVING, U.S. Provisional Application No. 60/707,329 (Attorney Docket No. 447/99/2/4); U.S. Provisional Application entitled METHODS AND APPARATUSES FOR GENERATING A SEAL BETWEEN A CONDUIT AND A RESERVOIR WELL, U.S. Provisional Application No. 60/707,286 (Attorney Docket No. 447/99/2/5); U.S. Provisional Application entitled MICROFLUIDIC SYSTEMS, DEVICES AND METHODS FOR REDUCING DIFFUSION AND COMPLIANCE EFFECTS AT A FLUID MIXING REGION, U.S. Provisional Application No. 60/707,220 (Attorney Docket No. 447/99/3/1); U.S. Provisional Application entitled MICROFLUIDIC SYSTEMS, DEVICES AND METHODS FOR REDUCING NOISE GENERATED BY MECHANICAL INSTABILITIES, U.S. Provisional Application No. 60/707,245 (Attorney Docket No. 447/99/3/2); U.S. Provisional Application entitled MICROFLUIDIC CHIP APPARATUSES, SYSTEMS, AND METHODS HAVING FLUIDIC AND FIBER OPTIC INTERCONNECTIONS, U.S. Provisional Application No. 60/707,246 (Attorney Docket No. 447/99/4/2); U.S. Provisional Application entitled METHODS FOR CHARACTERIZING BIOLOGICAL MOLECULE MODULATORS, U.S. Provisional Application No. 60/707,328 (Attorney Docket No. 447/99/5/1); U.S. Provisional Application entitled METHODS FOR MEASURING BIOCHEMICAL REACTIONS, U.S. Provisional Application No. 60/707,370 (Attorney Docket No. 447/99/5/2); U.S. Provisional Application entitled METHODS AND APPARATUSES FOR REDUCING EFFECTS OF MOLECULE ADSORPTION WITHIN MICROFLUIDIC CHANNELS, U.S. Provisional Application No. 60/707,366 (Attorney Docket No. 447/99/8); U.S. Provisional Application entitled PLASTIC SURFACES AND APPARATUSES FOR REDUCED ADSORPTION OF SOLUTES AND METHODS OF PREPARING THE SAME, U.S. Provisional Application No. 60/707,288 (Attorney Docket No. 447/99/9); U.S. Provisional Application entitled BIOCHEMICAL ASSAY METHODS, U.S. Provisional Application No. 60/707,374 (Attorney Docket No. 447/99/10); U.S. Provisional Application entitled FLOW REACTOR METHOD AND APPARATUS, U.S. Provisional Application No. 60/707,233 (Attorney Docket No. 447/99/11); and U.S. Provisional Application entitled MICROFLUIDIC SYSTEM AND METHODS, U.S. Provisional Application No. 60/707,384 (Attorney Docket No. 447/99/12).

### TECHNICAL FIELD

The subject matter disclosed herein relates to microfluidic systems, devices and methods for fabricating and using the same. More particularly, the subject matter disclosed herein relates to microfluidic systems, devices and methods for reducing background autofluorescence and the effects thereof.

### BACKGROUND ART

Microfluidic systems have been developed for miniaturizing and automating the acquisition of biological and biochemical information, in both preparative and analytical capacities. These systems have resulted in decreased cost and improved data quality. Microfluidic systems typically include one or more microfluidic chips for conducting and mixing small amounts of fluid, reagent, or other flowable composition or chemical for reaction and observation. Microfluidic chips can be fabricated using photolithography, wet chemical etching, laser micromachining, and other techniques used for the fabrication of microelectromechanical systems. Generally, microfluidic systems can also include one or more computers, detection equipment, and pumps for controlling the fluid flow into and out of the chip for mixing two or more reagents or other fluids together at specific concentrations and observing any resulting reaction.

Typically, microfluidic chips include a central body structure in which various microfluidic elements are formed for conducting and mixing fluids. The body structure of the microfluidic chip can include an interior portion which defines microscale channels and/or chambers. Typically, two or more different fluids are advanced to a mixing junction or region at a controlled rate from their respective sources for mixing at desired concentrations. The mixed fluids can then be advanced to at least one main channel, a detection or analysis channel, whereupon the mixed fluids can be subjected to a particular analysis by detection equipment and analysis equipment, such as a computer. Typically, the detection equipment includes a light source for illuminating the mixed fluids contained in the detection channel/region for detection by a light detector. The light can be reflected from and/or pass through the contents of the detection channel/region for detection by the light detector.

A primary challenge in the design of microfluidic chips is reducing unwanted background autofluorescence when fluorescence of a reporter molecule in the reaction is used to measure the extent of the reaction. Background autofluorescence can substantially increase the signal-to-background and signal-to-noise ratio in such measurements. In order to obtain quality data, the light related to the channel contents must be reliably distinguished from the background autofluorescence generated by other sources, such as autofluorescence from the substrate material into which the microfluidic channel has been formed.

Glass substrate materials have been used to reduce background autofluorescence, although glass substrate materials can be difficult to manufacture into a microfluidic chip. Polymeric material is typically easier to manufacture into a microfluidic chip. Thus, it would be advantageous to provide microfluidic chips made of polymeric material having reduced background autofluorescence. Therefore, a variety of “low autofluorescence” polymers have been developed for reducing background autofluorescence. However, these polymers still have some autofluorescence, and can significantly increase signal-to-background and decrease the signal-to-noise ratio.

Therefore, it is desirable to provide improved microfluidic systems, devices and methods for fabricating and using the same. It is also desirable to improve the design of microfluidic systems for reducing background autofluorescence and effects thereof. More specifically, it is desirable to reduce background autofluorescence originating from the material out of which the microfluidic chips are made.

### SUMMARY

According to one embodiment, a microfluidic system and method is disclosed for reducing autofluorescence. The microfluidic system can include a light source for generating an excitation light. The microfluidic system can also include a microscope having an objective for focusing the excitation light on a fluid inside a microfluidic channel of a microfluidic chip. Further, the microfluidic system can include a detector for rejecting out-of-focus light emitted from the microfluidic chip.

According to a second embodiment, a microfluidic system and method is disclosed for reducing autofluorescence. The microfluidic system can include a light source for generating an excitation light. The microfluidic system can also include a microscope comprising an objective for focusing the excitation light on a fluid inside a microfluidic channel of a microfluidic chip, wherein the excitation light illuminates the fluid for generating emitted fluorescent light. Further, the microfluidic system can include a shielding comprising an opening. The microfluidic system can also include a first convex lens positioned to receive the emitted fluorescent light and focus the emitted light through the opening of the shielding for eliminating unwanted background autofluorescence. Further, the microfluidic system can include a detector for detecting the light passing through the opening of the shielding

According to a third embodiment, a method is provided for reducing autofluorescence in a microfluidic system. The method can include generating an excitation light. The method can also include focusing the excitation light on a fluid inside a microfluidic channel of a microfluidic chip, wherein the excitation light illuminates the fluid for generating fluorescent light. Further, the method can include rejecting out-of-focus light for eliminating unwanted background autofluorescence. The method can also include detecting the fluorescent light.

According to a fourth embodiment, a microfluidic device for reducing autofluorescence is provided. The device can include a microfluidic chip that encloses a microscale channel. The device can also include a support frame connected to the microfluidic chip for supporting the microfluidic chip.

According to a fifth embodiment, a microfluidic device for reducing autofluorescence is provided. The device can include providing a first thin film including a microscale channel fabricated therein. The device can also include a second thin film connected to the first thin film. Further, the device can include a support frame connected to the first or second thin film for supporting the first or second thin film.

According to a sixth embodiment, a method for fabricating a microfluidic device having reduced autofluorescence is provided. The method can include providing a microfluidic chip including first and second portions, wherein the first portion includes a microscale channel. The method can also include providing a support frame operable to support the microfluidic chip. Further, the method can include attaching the support frame to the second portion of the microfluidic chip.

According to a seventh embodiment, a method for fabricating a microfluidic device having reduced autofluorescence is provided. The method can include providing a substrate. The method can also include photobleaching the substrate. Further, the method can include fabricating a microscale channel in the substrate.

According to an eighth embodiment, a method for fabricating a microfluidic device having reduced autofluorescence is provided. The method can include providing a substrate. The method can also include exposing the substrate to a wavelength matching the excitation wavelength of the substrate. Further, the method can include fabricating a microscale channel in the substrate.

According to a ninth embodiment, a method for fabricating a microfluidic device having reduced autofluorescence is provided. The method can include providing a microfluidic chip. The method can also include exposing the microfluidic chip to ultraviolet light including a wavelength matching the excitation wavelength used to analyze fluids in the microfluidic chip.

According to a tenth embodiment, a method for reducing autofluorescence in a microfluidic chip is provided. The method can include providing a microfluidic chip including a deep channel. Further, the method can include generating an excitation light. The method can also include focusing the excitation light on a fluid inside the deep channel. The excitation light can illuminate the fluid for generating fluorescent light. Further, the method can include detecting the fluorescent light.

It is therefore an object to provide novel microfluidic systems, devices and methods for reducing background autofluorescence and the effects thereof.

### BRIEF DESCRIPTION OF THE DRAWINGS

Exemplary embodiments of the presently disclosed subject matter will now be explained with reference to the accompanying drawings, of which:

FIG. 1 is a schematic diagram of an exemplary embodiment of a microfluidic system for generating and mixing continuous concentration gradients of fluids;

FIG. 2 is a schematic diagram of the channel and mixing region layout of a microfluidic chip;

FIG. 3 is an exemplary graph showing the noise generated by autofluorescent background in a detected fluorescent signal by running a square-wave mixing profile in a microfluidic chip;

FIG. 4 is a schematic diagram of confocal illumination and detection equipment for use with a microfluidic chip;

FIG. 5A is a schematic diagram illustrating a shielding which functions as a spatial filter for fluorescent light;

FIG. 5B is a schematic diagram illustrating a pseudo-confocal system in which two lasers are used to simultaneously excite two fluorophores in the fluid flowing through microfluidic channel inside a microfluidic chip;

FIG. 6 is an exploded perspective view of a microfluidic chip having a minimal amount of material for reducing background autofluorescence;

FIG. 7 is a flow chart of an exemplary process for photobleaching process a microfluidic chip;

FIG. 8 is an exemplary graph showing the noise generated by autofluorescent background in a detected fluorescent signal by running a square-wave mixing profile in a microfluidic chip after the microfluidic chip has been subjected to a photobleaching process;

FIG. 9A is a schematic diagram of a microfluidic device with a shallow channel;

FIG. 9B is a schematic diagram of a microfluidic device with a channel having a deep portion at the point of measurement by the microfluidic device;

FIG. 10 is a schematic top view of an embodiment of an analysis channel disclosed herein and upstream fluidly communicating microscale channels;

FIG. 11A is a schematic cross-sectional side view of an embodiment of analysis channel disclosed herein and upstream fluidly communicating microscale channel; and

FIG. 11B shows schematic cross-sectional cuts at A-A and B-B of the analysis channel of FIG. 11A.

### DETAILED DESCRIPTION

Microfluidic chips, systems, devices and related methods are described herein which incorporate improvements for reducing background autofluorescence and the effects thereof. These microfluidic chips, systems, devices and methods are described with regard to the accompanying drawings. It should be appreciated that the drawings do not constitute limitations on the scope of the disclosed microfluidic chips, systems, and methods.

As used herein, the term “autofluorescence” generally refers to the natural, inherent fluorescent light that is emitted by a substrate when the substrate is irradiated with an excitation light.

As used herein, the term “fluid” generally means any flowable medium such as liquid, gas, vapor, supercritical fluid, combinations thereof, or the ordinary meaning as understood by those of skill in the art.

As used herein, the term “vapor” generally means any fluid that can move and expand without restriction except for at a physical boundary such as a surface or wall, and thus can include a gas phase, a gas phase in combination with a liquid phase such as a droplet (e.g., steam), supercritical fluid, the like, or the ordinary meaning as understood by those of skill in the art.

As used herein, the term “reagent” generally means any flowable Composition or chemistry. The result of two reagents combining together is not limited to any particular response, whether a biological response or biochemical reaction, a dilution, or the ordinary meaning as understood by those of skill in the art.

In referring to the use of a microfluidic chip for handling the containment or movement of fluid, the terms “in”, “on”, “into”, “onto”, “through”, and “across” the chip generally have equivalent meanings.

As used herein, the term “computer-readable medium” refers to any medium that participates in providing instructions to the processor of a computer for execution. Such a medium may take many forms, including but not limited to, non-volatile media, volatile media, and transmission media. Non-volatile media include, for example, optical or magnetic disks. Volatile media include dynamic memory, such as the main memory of a personal computer, a server or the like. Transmission media include coaxial cables; copper wire and fiber optics, including the wires that form the bus within a computer. Transmission media can also take the form of electric or electromagnetic signals, or acoustic or light waves such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, or any other computer-readable medium. Various forms of computer readable media may be involved in carrying one or more sequences of one or more instructions to the processor for execution. Alternatively, hard-wired circuitry may be used in place of or in combination with software instructions to implement the subject matter. Thus, embodiments of the subject matter are not limited to any specific combination of hardware circuitry and software.

As used herein, the term “microfluidic chip,” “microfluidic system,” or “microfluidic device” generally refers to a chip, system, or device which can incorporate a plurality of interconnected channels or chambers, through which materials, and particularly fluid borne materials can be transported to effect one or more preparative or analytical manipulations on those materials. A microfluidic chip is typically a device comprising structural or functional features dimensioned on the order of mm-scale or less, and which is capable of manipulating a fluid at a flow rate on the order of several μl/min or less. Typically, such channels or chambers include at least one cross-sectional dimension that is in a range of from about 0.1 μm to about 500 μm. The use of dimensions on this order allows the incorporation of a greater number of channels or chambers in a smaller area, and utilizes smaller volumes of reagents, samples, and other fluids for performing the preparative or analytical manipulation of the sample that is desired.

Microfluidic systems are capable of broad application and can generally be used in the performance of biological and biochemical analysis, and detection methods. The systems described herein can be employed in research, diagnosis, environmental assessment and the like. In particular, these systems, with their micron and submicron scales, volumetric fluid control systems, and integratability, can generally be designed to perform a variety of fluidic operations where these traits are desirable or even required. In addition, these systems can be used in performing a large number of specific assays that are routinely performed at a much larger scale and at a much greater cost.

A microfluidic device or chip can exist alone or may be a part of a microfluidic system which, for example and without limitation, can include: pumps for introducing fluids, e.g., samples, reagents, buffers and the like, into the system and/or through the system; detection equipment or systems; data storage systems; and control systems for controlling fluid transport and/or direction within the device, monitoring and controlling environmental conditions to which fluids in the system are subjected, e.g., temperature, current and the like.

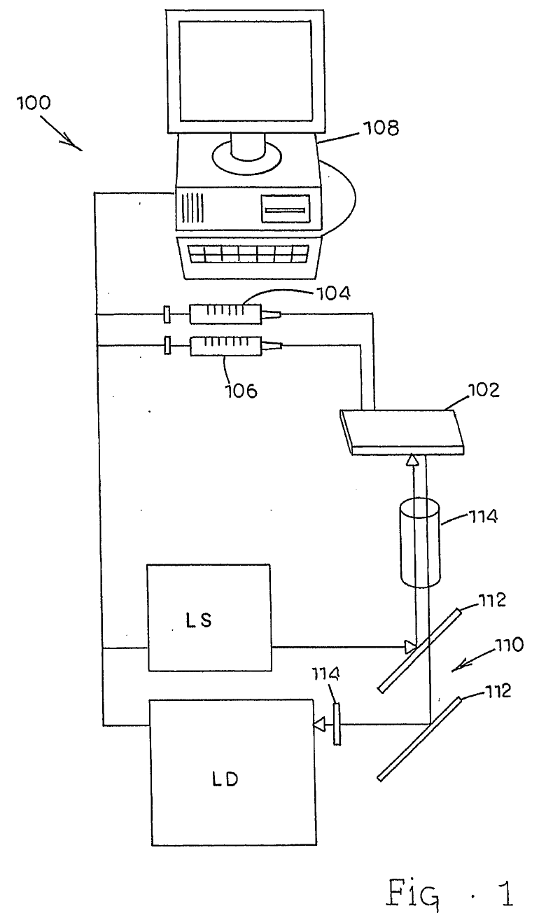

A schematic diagram of an exemplary embodiment of a microfluidic system, generally designated 100, for generating and mixing continuous concentration gradients of fluids is illustrated in FIG. 1. System 100 can include a microfluidic chip 102 having fluid connection to a first and second microfluidic pump 104 and 106 for advancing fluids through chip 102 for mix and analysis. In this embodiment, pumps 104 and 106 are syringe pumps, which can be driven by stepper or servo motors. Alternatively, pumps 104 and 106 can comprise peristaltic pumps, pressure-driven pumps, conducting polymer pumps, electro-osmotic pumps, bubble pumps, piezo-electric driven pumps, or another type of pump suitable for pumping fluids through microfluidic chips. Pumps 104 and 106 can produce volumetric flow rates that are individually controllable by a computer 108.

According to one embodiment, computer 108 can be a general-purpose computer including a memory for storing program instructions for operating pumps 104 and 106. Alternatively, computer 108 can include a disk drive, compact disc drive, or other suitable component for reading instructions contained on a computer-readable medium for operating pumps 104 and 106. Further, computer 108 can include instructions for receiving, analyzing, and displaying information received from detection equipment, generally designated 110, described in further detail below. Computer 108 can also include a display, mouse, keyboard, printer, or other suitable component known to those of skill in the art for receiving and displaying information to an operator.

Computer 108 can operate pumps 104 and 106 to produce smooth, continuous flows in a stable manner. As known to those of skill in the art, some pumps can produce volumetric flow rates as low as approximately one nanoliter per minute. As described further herein, pumps 104 and 106 can be controlled to produce a fluid mix at a mixing junction in microfluidic chip 102 that has a continuously varied ratio over time for producing continuous concentration gradients at the mixing junction.

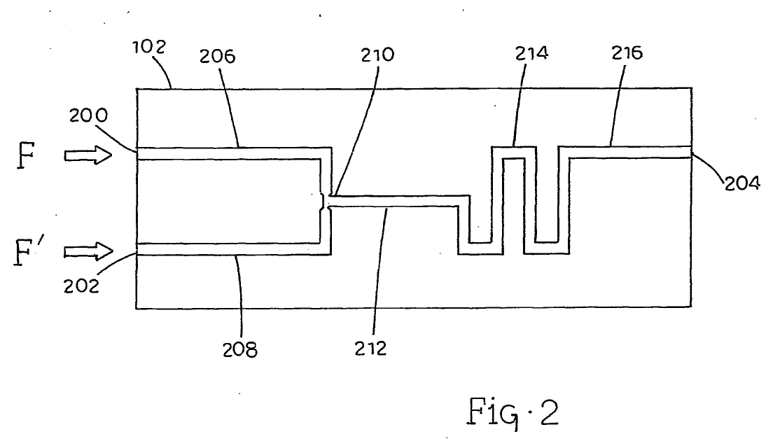

After mixing, a fluid mixture can be advanced to a detection channel/region, or analysis channel/region 216 (shown in FIG. 2 for example) on chip 102 and subjected to analysis by detection equipment 110. Typically, the mixed fluids travel a length of channel before reaching the detection channel/region 216 to enable passive mixing of the fluids and sufficient interaction of the components of the fluids, such as reacting components. The detection channel/region can include a point at which measurement, e.g., concentration, of the fluid mixture is acquired by a suitable data acquisition technique. Detection equipment 110 can be operably connected to computer 108 for receiving and storing the measurement acquired at the detection channel/region. Computer 108 can also perform analysis of measurement from detection equipment 110 and present an analysis of the measurement to an operator in a human-readable form. As fluid passes the detection channel/region, the fluid can flow to any suitable waste site for disposal.

A microfluidic chip, such as chip 102, can comprise a central body structure in which the various microfluidic elements are disposed. The body structure can include an exterior portion or surface, as well as an interior portion which defines the various microscale channels, fluid mixing regions, and/or chambers of the overall microscale device. For example, the body structures of microfluidic chips typically employ a solid or semi-solid substrate that is typically planar in structure, i.e., substantially flat or having at least one flat surface. Suitable substrates can be fabricated from any one of a variety of materials, or combinations of materials. Typically, the planar substrates are manufactured using solid substrates common in the fields of microfabrication, e.g., silica-based substrates, such as glass, quartz, silicon, or polysilicon, as well as other known substrates, such as sapphire, zinc oxide alumina, Group III-V compounds, gallium arsenide, and combinations thereof. In the case of these substrates, common microfabrication techniques such as photolithographic techniques, wet chemical etching, micromachining, i.e., drilling, milling and the like, can be readily applied in the fabrication of microfluidic devices and substrates. Alternatively, polymeric substrates materials can be used to fabricate the devices described herein, including, e.g., polydimethylsiloxanes (PDMS), polymethylmethacrylate (PMMA), polyurethane, polyvinylchloride (PVC), polystyrene polysulfone, polycarbonate, polymethylpentene, polypropylene, polyethylene, polyvinylidine fluoride, ABS (acrylonitrile-butadiene-styrene copolymer), cyclic olefin copolymers, and the like. In the case of such polymeric materials, laser ablation, injection molding, or embossing methods can be used to form the substrates having the channels and element geometries as described herein. For injection molding and embossing, original molds can be fabricated using any of the above described materials and methods.

Channels, fluid mixing regions and chambers of microfluidic chips can be fabricated into one surface of a planar substrate, as grooves, wells, depressions, or other suitable configurations in that surface. A second planar substrate, typically prepared from the same or similar material, can be overlaid and bonded to the first, thereby defining and sealing the channels, mixing regions, and/or chambers of the device. Together, the upper surface of the first substrate, and the lower mated surface of the upper substrate, define the interior portion of the device, i.e., defining the channels, fluid mixing junctions, and chambers of the device. Alternatively, the surfaces of two substrates can be etched and mated together for defining the interior portion of the device.

Microfluidic chips typically include at least one detection channel 216, also termed an analysis channel, through which fluids are transported and subjected to a particular analysis. Fluid samples can be advanced from their respective sources to the detection channel by placing the fluids in channels that intersect at a fluid mixing junction 210. The fluids are suitably advanced through the channels at predetermined fluid velocities to achieve desired gradients of fluid concentration, also known as “concentration gradients,” at the mixing region. As referred to herein, a concentration gradient is a change in the concentration of a fluid in a space along some distance of the fluid in space. As applied to microfluidic devices, for example, a concentration gradient can be considered the concentration change of a fluid along a length of a microfluidic channel. A concentration gradient can also be considered the concentration change over time of a fluid as it passes a point. Typical experiments can include varying the concentration gradients of fluids advanced to the mixing region and observing the resulting mixed fluids at a downstream detection channel. In order to obtain good analysis data, it is important to precisely control the concentration gradients of fluids at the mixing region. Unanticipated or uncontrolled motions of the fluid can alter the shape of the resulting concentration gradient. Even very small movements of the liquid (equaling volumes of only one nanoliter for example) that would be insignificant for larger systems can be problematic, due to the very slow flow rates used in microfluidic devices.

These unanticipated or uncontrolled motions of the fluid appear as noise in the signal measured from the concentration gradient. For example, if one of pumps 104 or 106 was pumping a fluorescent agent, and the flow that pump oscillated in an unanticipated manner, then the resulting concentration gradient downstream would have that oscillation appear as an oscillating fluorescent signal. This unanticipated oscillation would appear as noise in the measured signal.

Concentration gradient noise can be observed as a fluctuating concentration of fluid where the concentration gradient should be constant or smoothly changing with respect to time or space.

Similarly, other sources of noise or of background in the signal measured from the concentration gradient can adversely affect analysis data. For example, a common problem is autofluorescence from the polymer forming the microfluidic channel. This autofluorescence can contribute significant background to the measured fluorescence signal, which, in turn, degrades the sensitivity of the instrument. Autofluorescence can also amplify other sources of noise, such as oscillations of the intensity of the laser. It is, therefore, desirable to reduce contributions of autofluorescence to the background of the signal.

In the embodiment of FIG. 1, detection equipment 110 can monitor the progress of resulting reactions of the mixed fluids at the detection channel via fluorescence. For example, as a reaction proceeds at the detection channel: fluorescence can increase due to generation of a fluorescent compound; fluorescence can decrease due to degradation of a fluorescent compound; fluorescence polarization can change due to changes in the rotational diffusion of a fluorescently-tagged molecule, e.g., during binding to a larger molecule; fluorescence lifetime can change due to changes in diffusional mobility or due to changes in chemical environment; and fluorescence wavelength (excitation and/or emission) can change. Similarly, absorption of light by a component of the reaction can be measured or the reagent stream can be sent to a mass spectrometer to measure the amount of specific component.

For fluorescence detection, a fluorescence microscope can be employed. Alternatively, any type of light path known to those of skill in the art can be employed. The excitation light sources can be any suitable light source LS, such as green Helium Neon (HeNe) lasers, red diode lasers, and diode-pumped solid state (DPSS) lasers (532 nanometers). Incandescent lamps and mercury and xenon arclamps in combination with chromatic filters or diffraction gratings with slits can also be used as excitation sources. Excitation sources can include combinations, such as multiple lasers or lasers combined with arclamps and chromatic filters and diffraction gratings with slits. Detection equipment 110 can include a light detector LD for detecting the light fluorescing from and/or passing through the detection channel/region where a reaction occurs. Avalanche photodiodes (APDs) and photo-multiplier tubes (PMTS) can also be used. Light source LS and light detector LD can be coupled to a microscope having mirrors 112 and optical lenses 114. Other optical configurations can be used, such as fiber optic delivery of light from the excitation source to the chip and from the sample in the chip to the photodetector.

Other methods for detection can include phosphorescence, variants of fluorescence (e.g., polarization fluorescence, time-resolved fluorescence, fluorescence emission spectroscopy, fluorescence resonant energy transfer), and other non-optical techniques using sensors placed into the fluid flow, such as pH or other ion-selective electrodes, conductance meters, and capture/reporter molecules.

Computer 108 can include hardware and software computer program products comprising computer-executable instructions embodied in computer-readable media for controlling pumps 104 and 106. Computer 108 can also control and analyze the measurements received from detection equipment 110. Computer 108 can provide a user interface for presenting measurements and analysis to an operator and receiving instructions from an operator. Certain concepts discussed herein relate to a computer program product, for causing computer 108 to control pumps 104 and 106, light source LS, and light detector LD. Different methods described herein for controlling the components of system 100 can be implemented by various computer program products. For example, a programmable card can be used to control pumps 104 and 106, such as a PCI-7344 Motion Control Card, available from National Instruments Corporation, Austin, Tex. Methods for controlling pumps 104 and 106 to achieve a desired concentration gradient and receive analysis data from detection equipment 110 can be programmed using C++, LABVIEW™ (available from National Instruments Corporation), or any other suitable software. Such a computer program product comprises computer-executable instructions and/or associated data for causing a programmable processor to perform the methods described herein. The computer-executable instructions can be carried on or embodied in computer-readable medium.

Referring to FIG. 2, a schematic diagram of the channel and mixing region layout of microfluidic chip 102 is illustrated. Microfluidic chip 102 can include two inputs 200 and 202 connected to pumps 104 and 106 (shown in FIG. 1), respectively, for advancing fluids F and F′, respectively, through the channels of chip 102. Fluids F and F′ from inputs 200 and 202, respectively, can be advanced by pumps 104 and 106, respectively, through premixing channels 206 and 208, respectively, and combined downstream at a fluid mixing junction 210. Premixing channels 206 and 208 can also function to equilibrate the temperature of fluids F and F′, respectively, in the channels to a surrounding temperature. In an alternative embodiment, microfluidic chip 102 can include more than two channels for combining more than two separate, and different if desired, fluids F and F′ at the mixing junction or at multiple mixing junctions.

In the embodiment of FIG. 2, microfluidic chip 102 can operate as a passive mixer such that all mixing occurs by diffusion. Therefore, microfluidic chip 200 can include a mixing channel 212 downstream from mixing junction 210 to allow the fluids F and F′ to adequately mix prior to detection downstream. Alternatively, mixing can be enhanced by the inclusion of structures in the microfluidic channels that generate chaotic advection, or mixing can be actively performed by the inclusion of moving, mechanical stirrers, such as magnetic beads driven by an oscillating magnetic field. Mixing junction 210 can be configured in any suitable configuration, such as what is known as a T-junction as shown in FIG. 2. The fluid streams from channels 206 and 208 therefore can combine laterally towards each other.

Microfluidic chip 200 can also include a serpentine channel 214 in communication with mixing channel 212 and positioned downstream therefrom. Serpentine channel 214 can operate as an aging loop for allowing a reaction to proceed for a period of time before reaching a detection channel 216. The length of an aging loop and the linear velocity of the fluid determine the time period of the reaction. Longer loops and slower linear velocities produce longer reactions. The lengths of aging loops can be tailored to a specific reaction or set of reactions, such that the reactions have time to complete during the length of the channel. Conversely, long aging loops can be used and shorter reaction times can be measured by detecting at points closer to mixing junction 210.

An exemplary method for generating and mixing concentration gradients using microfluidic system 100 (shown in FIG. 1) will now be described hereinbelow. First, pumps 104 and 106 can be prepared with fluids and connected to microfluidic chip 102. Any suitable method can then be used to purge the channels of microfluidic chip 102 for removing any contaminants, bubbles, or any other substance affecting concentration. Further, configuration and calibration of detection equipment 110 can be effected.

Once microfluidic system 100 has been prepared, concentration gradients can be run through microfluidic chip 102. Pumps 104 and 106 can be activated to establish separate flows of separate, and different if desired, fluids into chip 102 for mixing and measurement. According to one embodiment, the total or combined volumetric flow rate established by the active pumps is maintained at a constant value during the run. In addition, the ratio of the individual flow rates established by respective pumps can be varied over time by individual control, thereby causing the resulting concentration gradient of the mixture to vary with time. The concentration gradient of interest is that of an analyte of interest relative to the other components of the mixture. The analyte of interest can be any form of reagent or component of a reagent. Exemplary reagents can include inhibitors, substrates, enzymes, fluorophores or other tags, and the like. As the reaction product passes through detection channel/region with varying concentration gradient, detection equipment 110 samples the resulting reaction flowing through at any predetermined interval. The measurements taken of the mixture passing through the detection channel/chamber can be temporally correlated with the flow ratio produced by pumps 104 and 106, and a response can be plotted as a function of time and concentration.

Pumps 104 and 106 can advance fluid in a microfluidic chip for combining fluids at a mixing junction 210. The pumps can vary the flow velocities of the fluids such that the total volumetric flow rate can be kept constant downstream from the mixing junction. The concentration gradients of the mixed fluids can be varied over time by increasing the flow rate of one pump while decreasing the flow rate generated by the other pump. For example, at time t=60, the flow rate generated by the first pump can have a relative value of 100% of the total volumetric flow rate, and the flow rate generated by the second pump can have the relative value of 0% at a particular time. The flow rate generated by the first pump can be decreased as the flow rate generated by the second pump is increased. The flow rates in the first and second channels can be oscillated between 0% and 100%.

Noise in the measured concentration gradient appears as a higher-frequency oscillation of the measured concentration, relative to the generated concentration gradient. Noise can enter by any of several mechanisms, including mechanical instabilities in the pumping and fluidic systems, mechanical vibration of the optical system, thermal movements of optical components, and others. The presence of a background signal generated by autofluorescence from the substrate of microfluidic chip 102 contributes to noise if the noise arises from events other than concentration-dependent fluorescence of the signal fluorophore. For example, if mechanical vibration causes the focus of the optical system to oscillate, then the background signal will oscillate as the optical coupling efficiency oscillates with the oscillating focus. This oscillating background will appear in the final measured signal as noise, and, clearly, larger background signals from larger autofluorescence and smaller true signals (e.g. lower concentrations of fluorophores in the fluid) make this problem more difficult.

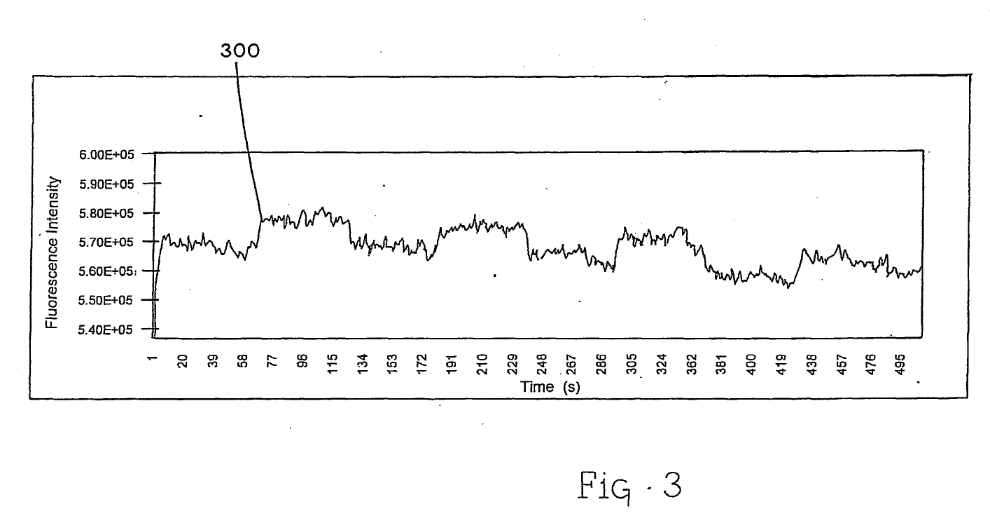

FIG. 3 illustrates an exemplary graph showing the noise generated by autofluorescent background in a detected fluorescent signal by running a square-wave mixing profile in a microfluidic chip, such as chip 102 shown in FIGS. 1 and 2. In the run, a low concentration, 1 nM, of resorufin dye was mixed with a buffer solution in four consecutive mixes. The resorufin dye can be advanced from one pump, such as first pump 104 shown in FIG. 1, and the buffer solution can be advanced from another pump, such as second pump 106 shown in FIG. 1, to mix at a mixing junction, such as mixing junction 210 shown in FIG. 2. Graph line 300 represents a signal corresponding to light detected from the contents of detection channel, such as detection channel 216 shown in FIG. 2, and background autofluorescence from chip 102. For this signal, the background is about 560,000 counts/second (cps) while the total signal generated by the low concentration of resorufin in this gradient is about 12,000 cps. The signal-to-background is 12/560−0.021. This signal shows two effects of autofluorescence—an overall decrease in the signal with time, arising from photobleaching of the autofluorescence, and an elevated higher amplitude of noise, arising from noise generated elsewhere in the measurement system that affects both the signal and the background (thus, a larger noise is created by the larger background).

Ideally, the detected signal should be a level square wave. The tops of the squares should all have one fluorescence intensity, and the bottoms of the squares should have a second, lower fluorescence intensity; however, as shown in FIG. 3, background autofluorescence causes the detected fluorescent signal to decay over time. Thus, the tops of the square waves are at lower fluorescence intensities as time progresses, as are the bottoms of the square waves. This gradual decrease in the background arises from photobleaching of the autofluorescent molecules in the polymer from which the chip is fabricated.

The high frequency noise in the signal causes the signal to look less like a square wave. Some of this higher frequency noise arises from various fluctuations in laser intensity and optical alignment arising from such sources as thermal expansion of components of the system arising from small thermal fluctuations in room temperature. These fluctuations produce percentage changes in the total signal, i.e., it produces a 1% oscillation in the fluorescence from the resorufin and from the polymer. 1% of 12,000 cps is 120 cps, while 1% of 560,000 cps is 5,600 cps (half the magnitude of the total signal from resorufin). This produces a signal-to-noise of 12,000/5,720−2.1. Thus, noise generated by fluctuations in laser intensity and optical alignment is exaggerated by the high background fluorescence.

### Confocal Illumination of Channel Contents

The signal-to-noise ratio in the detected fluorescent signal from a microfluidic chip, such as chip 102 shown in FIG. 1, can be substantially increased by preventing background autofluorescence from being detected by the optical system. Confocal systems strongly reject out of focus light from the specimen. Confocal illumination and detection equipment and related processes can be used to focus measurements on a point within a microscale channel such that background autofluorescence is out of focus and, therefore, rejected such that the contribution of unwanted background autofluorescence to the desired signal is reduced.

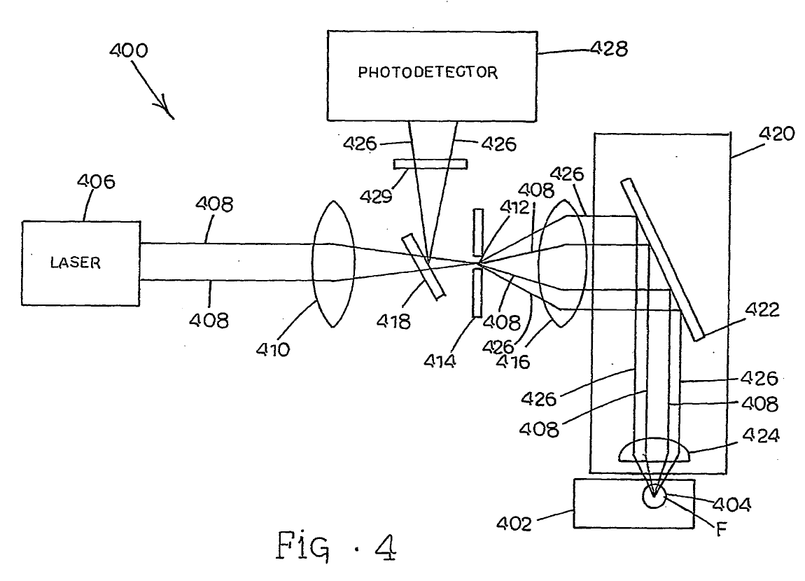

FIG. 4 illustrates a schematic diagram of confocal illumination and detection equipment, generally designated 400, for use with a microfluidic chip 402. Equipment 400 can also be used with other suitable microfluidic chips, such as chip 102 shown in FIG. 1, for focusing light on the interior of a detection channel, such as detection channel 216 shown in FIG. 2. Equipment 400 can be used to focus light on fluid F in the interior of a detection channel, rather than the material comprising chip 402 for reducing unwanted background autofluorescence from chip 402.

Initially, chip 402 can be held in a fixed position with respect to equipment 400 via clamps (not shown) or any other suitable method known to those of ordinary skill in the art. The interior of chip 402 can include detection channel 404 (shown in cross-section) having fluid F containing a fluorescent product for illumination and detection by equipment 400. Equipment 400 can also transmit signal data representing the detected fluorescent product to a computer, such as computer 108 shown in FIG. 1, for analysis and display to an operator.

Equipment 400 can include a laser 406 or other suitable light source known to those of ordinary skill in the art for illuminating fluid F with a beam of excitation light 408. Excitation light 408 can be directed to a convex lens 410 for focus through an opening 412 in an opaque shielding 414. Opening 412 can be positioned such that excitation light 408 passes through opening 412 of shielding 414 and reaches another convex lens 416 for collimation and expansion. Light 408 can also pass unaffected through a dichroic mirror 418, described in more detail below.

After passing convex lens 416, excitation light 408 can enter a microscope 420 for focusing excitation light 408 on fluid F containing a fluorescent product. Microscope 420 can include a 100% mirror 422 or the like for receiving and redirecting excitation light 408 toward channel 404. Microscope 420 can also include an objective 424 for focusing excitation light 408 from mirror 422 on fluid F. Microscope 420 and chip 402 can be positioned with respect to one another such that objective 424 focuses excitation light 408 on fluid F.

A portion of excitation light 408 can reach fluid F for illuminating a fluorescent product in fluid F. The excitation light 408 excites the fluorescent product which emits fluorescent light (light rays labeled as 426) that is then collected by microscope 420. This light 426 can enter microscope 420 through objective 424. Objects other than fluid F, such as chip 402, can also be illuminated by excitation light 408 and other light sources to generate unwanted reflections and unwanted background autofluorescence that enter microscope 420 through objective 424.

Light beams 426 can be directed by objective 424 to mirror 422 for reflection to lens 416. Lens 416 can focus fluorescent light 426 on opening 412 for passing shielding 414. Only light that was in focus at location 404 will be in focus at opening 412. Thus, only this light will be passed through shielding 414. Unwanted reflections and background fluorescence from portions of substrate 402 that were not in focus at location 404 hit shielding 414, and do not pass through opening 412. Light that is passed through opening 412 hits a dichroic mirror 418 which directs the fluorescently-emitted light 426 to a photodetector 432. If desired, an additional emission filter 429, can be placed in the light path before the photodetector to eliminate any residual reflected excitation light from the detected light. Photodetector 430 can receive light 426 and convert light 426 to an electrical signal representation of fluorescent light 426 for transmission to a computer, such as computer 108 shown in FIG. 1, for analysis and display.

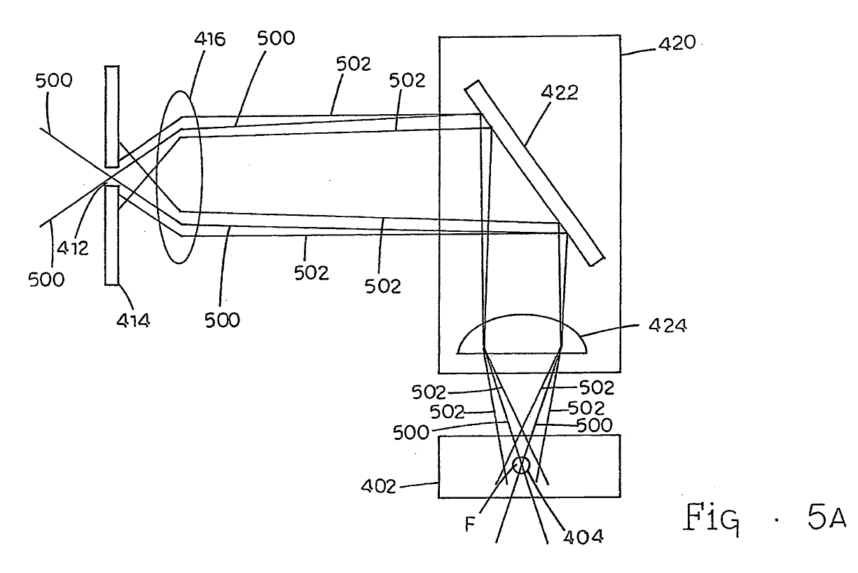

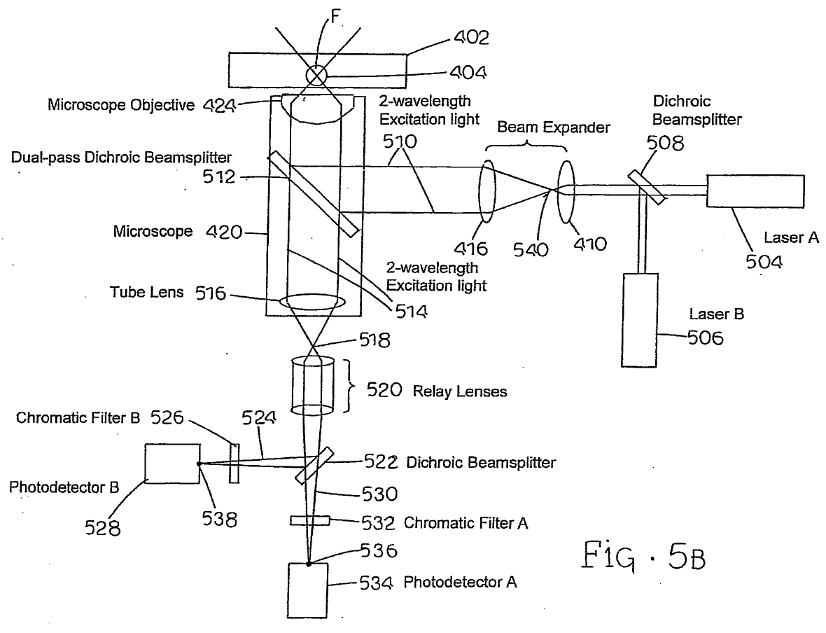

Opening 412 can function as a spatial filter for light 426 to reduce background autofluorescence. Referring to FIG. 5A, a schematic diagram is provided which illustrates shielding 414 functioning as a spatial filter for light beam 426. FIG. 5A shows paths of light beams that pass through the confocal pinhole or opening and those that do not pass through the opening. Opening 412 is positioned to only pass light, indicated by reference numeral 500, which emanates from the point of focus 404 of objective 424. Light, indicated by reference numeral 502, that does not emanate from the point of focus 404 of objective 424 is absorbed by shielding 414 and does not pass through opening 412. Light 502, the unwanted background autofluorescence, is shown in FIG. 5 as originating from microfluidic chip 402.

It is possible to create a “pseudo-confocal” system without the openings 412. If the photodetector is so small that it is, effectively, a spot, then the photodetector can be positioned at the focus point of the emitted fluorescent light. FIG. 5B is a schematic diagram illustrating a pseudo-confocal system in which two lasers are used to simultaneously excite two fluorophores in the fluid F flowing through microfluidic channel 404 inside microfluidic chip 402. Two lasers, a first laser 504 emitting a longer wavelength light (such as a 685 nm laser diode from Stocker Yale of Salem, N.H.) and a second laser emitting a shorter wavelength light 506 (such as a green HeNe laser emitting at 534 nm from Coherent, Inc. of Santa Clara, Calif., U.S.A.) have their beams made coaxial by dichroic beamsplitter 508. These beams are expanded by a two-lens system 410 and 416 to a broad beam of collimated light 510 that enters microscope 420. This light 510 is reflected by a dual-wavelength dichroic beamsplitter 512 toward the microscope objective 424 which focuses the light into a microfluidic channel 404 containing fluid F inside microfluidic chip 402. Fluorescent light emitted by fluorophores (such as resorufin and Alexa 700 from Molecular Probes of Eugene, Oreg.) is then collected by microscope objective 424. This light passes through dichroic reflector 512 creating a collimated beam of light 514 containing the emission spectra of both fluorophores. This emitted light 514 is then focused by the microscope tube lens 516 to a point 518 which is then projected out of the microscope by relay lenses 520. This light is then split into two beams by beamsplitter 522: a first beam 524 of shorter wavelength from the resorufin which is filtered by a chromatic filter 526 and measured by a photodector 528 and a second beam 530 of longer wavelength from the Alexa 700 which is filtered by a chromatic filter 532 and measured by a photodetector 534. Photodetectors 534 and 528 can have point detectors 536 and 538, respectively, that are so small that only light focused from inside microfluidic channel 404 can be measured—any out of focus light from autofluorescence of the polymer of the microfluidic chip 402 will strike outside the point detector and not be measured. An example of such a small spot detector is the avalanche photodiode model SPCM-AQR available from PerkinElmer, Inc. of Wellesley, Mass. Thus, a pinhole or opening 412 is not used as in FIGS. 4 and 5, but out of focus light from autofluorescence is still rejected. Nevertheless, if further rejection is needed, confocal pinholes can be placed at focal point 540 for the excitation light and at focal point 518 for the emission light.

### Thin Microfluidic Chips

Background autofluorescence can be reduced by minimizing the amount of material causing background autofluorescence. Because microfluidic chip material is a primary source of background autofluorescence, background autofluorescence can be reduced by minimizing the amount of material used to fabricate the microfluidic chip.

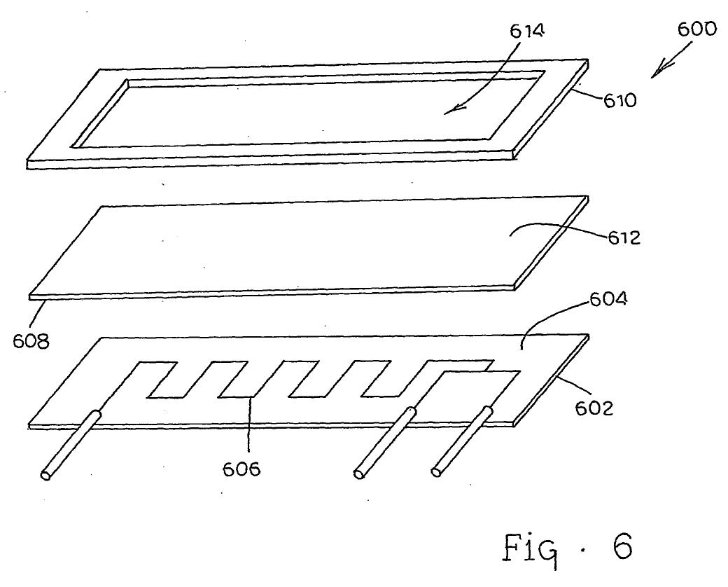

Referring to FIG. 6, an exploded perspective view of a microfluidic chip, generally designated 600, having a minimal amount of material for reducing background autoflourescence is illustrated. FIG. 6 shows chip 600 made out of thin material to minimize background autofluorescence. Microfluidic chip 600 can include a bottom substrate 602 having a surface 604 with a plurality of microscale channels 606 etched therein. Substrate 602 can comprise a thin film of polystyrene or polycarbonate of suitable thickness, for example approximately 125 micrometers thick. Alternatively, substrate 602 can comprise another suitable polymeric or suitable substrate material of suitable thickness. Additionally, any of the materials above can be used having thicknesses as small as approximately 25 micrometers can be used.

Microfluidic chip 600 can include a top substrate 608 for enclosing microscale channels 606. Top substrate 608 can be bonded or otherwise suitably attached to surface 604. Top substrate 608 can comprise a thin film of polystyrene or polycarbonate of suitable thickness, for example approximately 125 micrometers thick. Alternatively, top substrate 608 can comprise another suitable polymeric or suitable substrate material of suitable thickness. Additionally, any of the materials above can be used having thicknesses as small as 10 micrometers can be used.

According to one embodiment, microfluidic chip 600 can also include a support frame 610 for supporting the combination of substrates 602 and 608. In this embodiment, frame 610 can be attached to the perimeter of a surface 612 of top substrate 608. Alternatively, frame 610 can be attached to the perimeter of either substrate 602 or 608 for supporting substrates 602 and 608. Frame 610 can comprise a suitable structural material, such polystyrene, or another suitable rigid material for supporting a thin chip. In this embodiment, frame 610 can comprise an opaque material. Frame 610 can include a window, generally designated 614, positioned such that channels 606 can be viewed.

As an alternative to support frame 610, microfluidic chip 600 can include a rigid, transparent slide with minimal autofluorescence for supporting substrates 602 and 608. Alternatively, glass or any other transparent, rigid, low-autofluorescence material known to those of skill in the art, such as quartz or sapphire, can be used.

### Photobleaching Microfluidic Chips

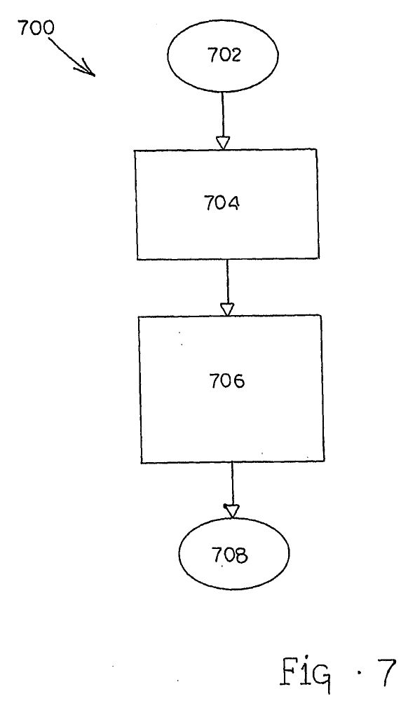

Autofluorescence can also be reduced by photobleaching microfluidic chips, such as microfluidic chip 102 shown in FIG. 1, prior to use. Photobleaching can include exposing the chip to an intense beam of light. Referring to FIG. 7, a flow chart, generally designated 700, is provided to illustrate an exemplary process for photobleaching a microfluidic chip, such as microfluidic chip 102 shown in FIG. 1. The process begins at start step 702. In step 704, a microfluidic chip 102 is provided. Next, the microfluidic chip can be exposed to a suitable photobleach light, such as ultraviolet light, for bleaching the chip (step 706). Alternatively, any light having a wavelength similar to the excitation wavelength can be used to bleach the chip. Examples of light sources that can be used to photobleach the substrate include broad-spectrum light sources, such as arc lamps and sunlight, as well as more monochromatic light sources, such as lasers and light-emitting diodes. The exposure time depends upon the intensity of the exposing light and the desired amount of photobleaching. Time between 10 minutes and 24 hours can be used. Next, the process can stop at step 708.

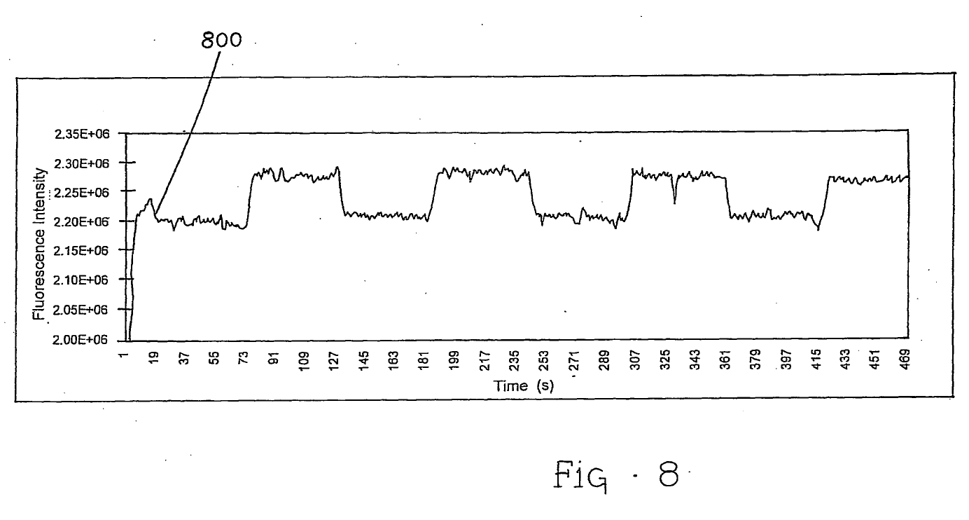

FIG. 8 illustrates an exemplary graph showing the noise generated by autofluorescent background in a detected fluorescent signal by running a square-wave mixing profile in a microfluidic chip, such as chip 102 shown in FIGS. 1 and 2, after the microfluidic chip has been subjected to a photobleaching process. The run shown in FIG. 8 included the same dye and buffer solution mix as the run shown in FIG. 3. Graph line 800 represents the detected light signal. As shown, the tops of the square wave signal as a function of time are now of equal intensity. Similarly, the bottoms of the square wave signal as a function of time are now of equal intensity. Graph line 800 shows no decay with time as compared to the run shown by graph line 300 in FIG. 3 in which substantial decay with time was observed as a result of photobleaching of the autofluorescence by the excitation source used in that experiment.

The contribution of autofluorescence can also be reduced by simply removing the autofluorescent material further from the focal plane of the optical system. This can be accomplished by increasing the depth of the channel at the point of measurement and focusing the system at the middle of this deeper channel. This is effective because it both decreases background and it increases signal. It decreases background both because the intensity of light delivered to a point along the optical path decreases with the square of the distance from the focal plane (thus, there is lower overall fluorescence per unit area further from the focal plane) and because the efficiency of collection of light decreases with the square of the distance to the focal plane (thus, less of this autofluorescence is projected by the optical system to the detector). It increases the signal because the volume of space that would otherwise be filled with autofluorescent material is now filled with the analyte (thus, increasing the signal).

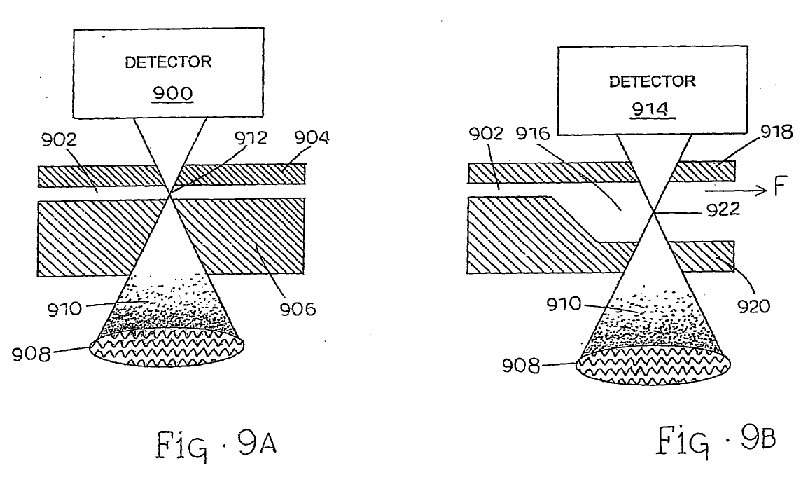

FIG. 9A illustrates a microfluidic device with a shallow channel 902. Channel 902 is formed between a top substrate 904 and a bottom substrate 906. Optical lens 908 can project a beam of excitation light 910 such that its focal plane 912 is focused at the mid-depth of channel 902. For shallow channel 902, the autofluorescent substrate is located closer to focal plane 912, elevating the contribution of autofluorescence to background. The excitation light 910 is received by a detector 900.

FIG. 9B illustrates a microfluidic device with a channel having a deep portion 916 at the point of measurement by a detector 914. Autofluorescent substrates 918 and 920 can be removed from a focal plane 922, reducing the contribution of autofluorescence to background. Additionally, analyte fluid F in deeper portion 916 now fills the volume otherwise occupied by autofluorescent substrate, resulting in capture of more fluorescence from the analyte and, thus, an increase in signal. Therefore, signal-to-background is increased in both by the decreased background and by the increased signal.

### Controlling Adsorption Effects

Adsorption of a molecule to the wall of a microfluidic channel can sometimes present a problem in microfluidic and other miniaturized systems in which the ratio of surface area to volume is many orders of magnitude larger than is found in more conventional approaches, such as for example, dispensing and mixing of solutions in microtiter plates. Adsorption of molecules in microfluidic systems and other miniaturized devices can be a major obstacle to miniaturization as the adsorption can affect molecule concentrations within fluids, thereby negatively impacting data collected from the microfluidic systems or other miniaturized devices. Adsorption driven changes in concentration can be especially problematic for microfluidic systems used to generate concentration gradients.

In some embodiments, the presently disclosed subject matter provides apparatuses and methods for using the same that can decrease the interference of adsorption to concentration dependent measurements, such as in biochemistry reactions including IC₅₀ determinations, by altering the geometry of a microfluidic channel. Although adsorption may not be eliminated, the change in concentration caused by adsorption can be minimized. In general terms, the effects of adsorption on measurements can be minimized by reducing the ratio of channel surface area to fluid volume within the channel (S/V), which also increases diffusion distances. However, as a high surface area to volume ratio can be an unavoidable consequence of the miniaturization of microfluidics, the geometries provided by some embodiments of the presently disclosed subject matter to minimize adsorption consequences are most unexpected by persons in the field of microfluidics. The presently disclosed subject matter provides for, in some embodiments, using large channel diameters in regions of the microfluidic chip most affected by adsorption of reaction components, that is, in regions where a reaction proceeds and/or where measurements are taken. In some embodiments of the presently disclosed subject matter, and with reference to the microfluidic chip embodiment shown in FIG. 2, large channel diameters at detection point of detection channel 216 can be provided to reduce adsorption effects, as a substitute for or in combination with serpentine channel 214 (also referred to as aging loop).

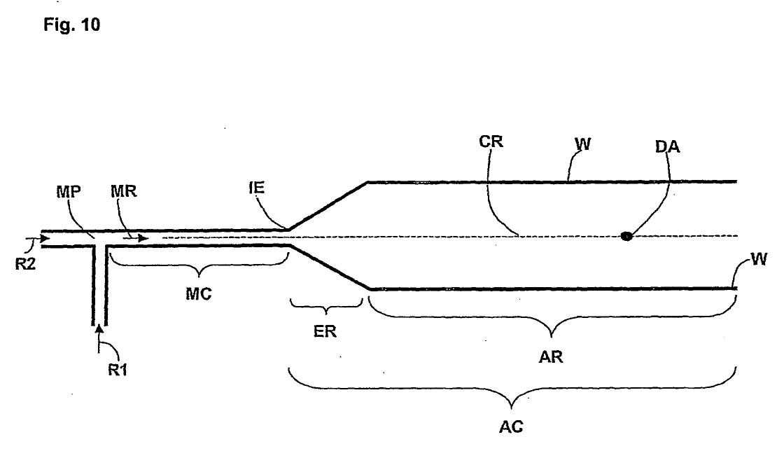

Turning now to FIG. 10, an embodiment of a novel analysis channel of the presently disclosed subject matter is illustrated in a top view. FIG. 10 shows the direction of flow by arrows R1 and R2 of two fluid reagent streams, which can combine at a merge region or mixing point MP. After combining into a merged fluid stream, the reagents within the stream can flow in a direction indicated by arrow MR down a mixing channel MC that can be narrow to permit rapid diffusional mixing of the reagent streams, thereby creating a merged fluid reagent stream. The fluid stream of reagents can then pass into an analysis channel AC, at an inlet or inlet end IE that can have a channel diameter and a cross-sectional area equivalent to that of mixing channel MC. The merged fluid stream can then flow through an expansion region ER that can have a cross-sectional area that can gradually increase and where the surface area to volume ratio can thereby gradually decrease. The merged fluid stream can then continue into an analysis region AR of analysis channel AC with an enlarged cross-sectional area and a reduced surface area to volume ratio. A reaction can be initiated by mixing of the reagent streams at the mixing point MP. However, due to continuity of flow, the flow velocity slows dramatically in analysis region AR of analysis channel AC, and the majority of transit time between mixing point MP and a detection area DA is spent in the larger diameter analysis region AR. Measurements can be made inside this channel, such as with confocal optics, to achieve measurements at detection area DA, which can be located at a center axis CR of analysis region AR of analysis channel AC. Center analysis region CR can be a region equidistant from any channel wall W of analysis channel AC. Thus, the fluid at center analysis region CR of detection area DA can be effectively “insulated” from adsorption at channel walls W. That is, the amount of any reagents removed at channel wall W can be too small, due to the greatly decreased surface area, and the diffusion distance to channel wall W can be too long, due to the greatly increased diffusion distance from center analysis region CR to channel wall W, to greatly affect the concentration at centerline CL. The confocal optics, for example, can reject signal from nearer channel wall W of analysis region AR, permitting measurements to be made at center analysis region CR where the concentration is least affected by adsorption at channel wall W.

A consequence of increasing analysis channel AC cross-section by increasing channel diameter is that the ratio of channel surface area to fluid volume (S/V) within the channel is decreased, relative to a narrower channel. For example, to measure a reaction 3 minutes after mixing, with a volumetric flow rate of 30 nL/min, the reaction should be measured at a point in the channel such that a microfluidic channel section spanning from mixing point MP to detection area DA encloses 90 nL. For an analysis channel with a square cross-section and a diameter of 25 μm, this point is about 144 mm downstream from mix point MP. This channel has a surface area of 1.44×10⁻⁵ square meters, yielding a surface to volume ratio S/V equal to 1.6×10⁵ m⁻¹. For a channel with a diameter of 250 μm, the measurement is made 1.44 mm downstream from mix point MP. This wider channel has a surface area of 1.44×10⁻⁶ square meters, yielding a S/V equal to 1.6×10⁴ m⁻¹, which is 1/10^{th} the S/V of the narrower channel. This alone can decrease ten-fold the removal of compound per unit volume by adsorption.

This geometry change can also decrease the radial diffusive flux of compound. Flow in these small channels is at low Reynolds number, so diffusion from a point in the fluid is the only mechanism by which compound concentration changes radially in a microfluidic channel. Increasing the radius of the channel, thereby decreasing the radial diffusive flux, therefore, means that the concentration of compound at center analysis region CR of analysis region AR can be less affected by adsorption than in the smaller upstream channels.

Thus, increasing the cross-sectional area of analysis region AR of analysis channel AC can both decrease the amount of adsorption at the wall per unit volume and decrease the rate of flux of compound from center analysis region CR to any of channel walls W. Both together mean that the concentration at center analysis region CR can decrease more slowly due to adsorption of compound.

Further, in all embodiments, the surface area of all channels exposed to compounds, not just analysis channel AC, can preferably be kept minimal, especially those channels through which concentration gradients flow. This can be accomplished by making channels as short as practicable. Additionally, when the volume contained by a channel must be defined (e.g. where the channel must contain a volume of 50 nL), it is best to use larger diameters/shorter lengths wherever possible to reduce S/V.

Another benefit of increasing analysis channel AC cross-section by increasing channel diameter is that the length of the channel down which the fluid flows can be reduced. In the example given earlier, a channel with 25 μm diameter needed to be 144 mm long to enclose 90 nl whereas the channel with 250 μm diameter needed to be only 1.44 mm long. This shorter channel can be much easier to fabricate and has a much smaller footprint on a microfluidic chip.

Still another benefit of increasing analysis channel AC cross-section is that it will behave like an expansion channel, which filters noise out of chemical concentration gradients, as disclosed in co-pending, commonly assigned U.S. Provisional Application entitled MICROFLUIDIC SYSTEMS, DEVICES AND METHODS FOR REDUCING NOISE GENERATED BY MECHANICAL INSTABILITIES, U.S. Provisional Application No. 60/707,245 (Attorney Docket No. 447/99/3/2), herein incorporated by reference in its entirety. The result is that signal to noise is larger in an analysis channel AC with larger cross-section.

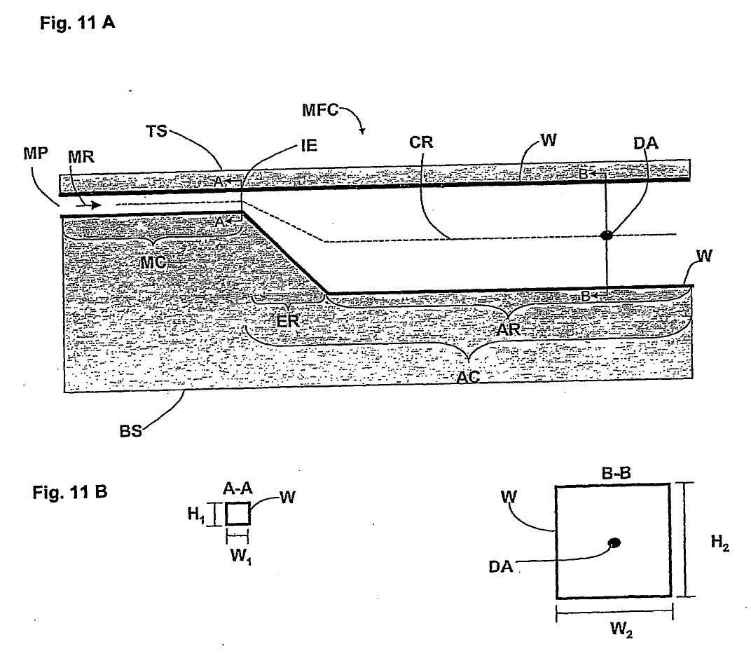

FIG. 11A presents a cross-sectional side view of a portion of a microfluidic chip MFC comprising mixing channel MC and analysis channel AC depicted in FIG. 10. Microfluidic chip MFC shown in FIG. 11A can be constructed by machining channels into a bottom substrate BS and enclosing channels by bonding a top substrate TS to bottom substrate BS or otherwise forming channels within microfluidic chip MC, with bottom substrate BS and top substrate TS being integral. In FIG. 11A, only the flow of merged reagent fluid stream having a flow direction indicated by arrow MR after mixing point MP is shown. Flow in a microfluidic channel can be at low Reynolds number, so the streamline of fluid that flows along center analysis region CR of the narrower mixing channel MC can travel at the mid-depth along entire mixing channel MC, becoming center analysis region CR of analysis region AR of analysis channel AC. Detection area DA can reside along center analysis region CR at a point sufficiently far downstream of mixing channel MC to permit the reaction to proceed to a desired degree.

Analysis channel AC can approximate a circular cross-section as closely as possible to produce the smallest ratio of surface area to volume, and also to produce the largest diffusion distance from centerline center analysis region CR to a channel wall W. However, microfluidic channels may not be circular in cross-section due to preferred manufacturing techniques. Rather, they can be more likely square in cross-section, with the exact shape depending on the technique used to form the channels. For such channels, a cross-section of analysis channel AC, particularly within analysis region AR, can have an aspect ratio as close to one as possible or, more precisely stated, the distance from center analysis region CR to channel wall W can be as nearly constant in all radial directions as possible.

FIG. 11B shows two different cross-sectional views along analysis channel AC as viewed along cutlines A-A and B-B. Both cross-sectional views illustrate an aspect ratio approximating one. That is, for cross-section A-A, height H₁ of mixing channel MC is approximately equal to width W₁ of mixing channel MC, such that H₁/W₁ approximately equals one. Comparably, for cross-section B-B, height H₂ of mixing channel MC is approximately equal to width W₂ of mixing channel MC, such that H₂/W₂ approximately equals one.

FIG. 11B further shows that the cross-sectional area (H₂×W₂) of analysis region AR at cutline B-B, which is located at detection area DA of analysis region AR, is significantly larger than the cross-sectional area (H₁×W₁) of input end IE at cutline A-A. In some embodiments of the presently disclosed subject matter, the cross-sectional area at detection area DA can be at least twice the value of the cross-sectional area value at input end IE and further upstream, such as in mixing channel MC. Further, in some embodiments, the cross-sectional area at detection area DA can be between about two times and about ten times the value of the cross-sectional area value at input end IE. As shown in cutline B-B of FIG. 11B, detection area DA can be positioned along center analysis region CR approximately equidistant from each of walls W to provide maximal distance from walls W, and thereby minimize effects of molecule adsorption to walls W. It is clear from FIG. 11B that the larger cross-sectional area at cutline B-B can provide both greater distance from walls W and smaller S/V than the smaller cross-sectional area at cutline A-A, both of which can reduce adsorption effects on data analysis, as discussed herein. Although detection area DA is shown in the figures as a circle having a distinct diameter, the depiction in the drawings is not intended as a limitation to the size, shape, and/or location of detection area DA within the enlarged cross-sectional area of analysis region AR. Rather, detection area DA can be as large as necessary and shaped as necessary (e.g. circular, elongated oval or rectangle, etc.) to acquire the desired data, while minimizing size as much as possible to avoid deleterious adsorption effects on the data. Determination of the optimal balance of size, shape and location while minimizing adsorption effects is within the capabilities of one of ordinary skill in the art without requiring undue experimentation.

Additional details and features of analysis channel AC are disclosed in co-pending, commonly assigned U.S. Provisional Application entitled METHODS AND APPARATUSES FOR REDUCING EFFECTS OF MOLECULE ADSORPTION WITHIN MICROFLUIDIC CHANNELS, U.S. Provisional Application No. 60/707,366 (Attorney Docket No. 447/99/8), herein incorporated by reference in its entirety.

In some embodiments, the presently disclosed subject matter provides apparatuses and methods for making and using the same that can decrease the interference of adsorption to concentration dependent measurements, such as in biochemistry reactions (including IC₅₀ determinations), by reducing adsorption of molecules to microfluidic channel walls. In some embodiments, the presently disclosed subject matter provides microfluidic chips comprising channels and chambers with treated surfaces exhibiting reduced adsorption of molecules to channel walls, such as for example hydrophilic surfaces, and methods of preparing and using the same. In some embodiments, methods of preparing hydrophilic surfaces by treating hydrocarbon-based plastics, such as for example polycarbonate, with fluorine gas mixtures are provided. In some exemplary embodiments, the methods comprise contacting a mixture of fluorine gas and an inert gas with the surface to be treated, then flushing the surface with air. This treatment results in plastic surfaces of increased hydrophilicity (increased surface energy). Hydrophobic solutes, in particular known and potential drug compounds, in solutions in contact with these treated hydrophilic plastic surfaces are less likely to be adsorbed onto the more hydrophilic surfaces. Plastics comprising the treated surfaces are useful in providing many improved drug discovery and biochemical research devices for handling, storing, and testing solutions containing low concentrations of hydrophobic solutes.

Additional details and features of hydrophilic surfaces in microfluidic systems and methods of making and using the same are disclosed in co-pending, commonly owned U.S. Provisional Application entitled PLASTIC SURFACES AND APPARATUSES FOR REDUCED ADSORPTION OF SOLUTES AND METHODS OF PREPARING THE SAME, U.S. Provisional Application No. 60/707,288 (Attorney Docket No. 447/99/9).

Further, in some embodiments of the presently disclosed subject matter, microfluidic systems are provided comprising an analysis channel with an enlarged cross-sectional area and a reduced surface area to volume ratio and further comprising channels and chambers with hydrophilic surfaces.

It will be understood that various details of the present subject matter can be changed without departing from the scope of the present subject matter. Furthermore, the foregoing description is for the purpose of illustration only, and not for the purpose of limitation.

1. A microfluidic system, comprising:
(a) a light source for generating an excitation light;
(b) a microscope comprising an objective for focusing the excitation light on a fluid inside a microfluidic channel of a microfluidic chip; and
(c) a detector for rejecting out-of-focus light emitted from the microfluidic chip.

2. The microfluidic system of claim 1, comprising a point detector positioned at a confocal point for rejecting the out-of-focus light.

3. The microfluidic system of claim 1, further comprising:
(a) a shielding comprising an opening;
(b) a first convex lens positioned to receive the excitation light from the light source and focus the excitation light on the opening of the shielding for passing the excitation light through the opening; and
(c) a second convex lens positioned to receive the excitation light passing through the opening for collimating the excitation light.

4. The microfluidic system of claim 3, wherein the second convex lens receives the fluorescent light from the fluid and focuses the fluorescent light through the opening of the shielding for spatially filtering unwanted background autofluorescence.

5. The microfluidic system of claim 4, further comprising a dichroic mirror positioned between the light source and the first convex lens for passing excitation light along a path to the first convex lens and positioned to redirect the fluorescent light passing through opening of the shielding to the detector.

6. The microfluidic system of claim 1, wherein the detector is operable to convert the fluorescent light into an electrical representation of the fluorescent light.

7. A microfluidic system, comprising:
(a) a light source for generating an excitation light;
(b) a microscope comprising an objective for focusing the excitation light on a fluid inside a microfluidic channel of a microfluidic chip, wherein the excitation light illuminates the fluid for generating emitted fluorescent light;
(c) a shielding comprising an opening;
(d) a first convex lens positioned to receive the fluorescent light and focus the fluorescent light through the opening of the shielding for eliminating unwanted background autofluorescence; and
(e) a detector for detecting the light passing through the opening of the shielding.

8. A method for reducing autofluorescence in a microfluidic system, the method comprising:
(a) generating an excitation light;
(b) focusing the excitation light on a fluid inside a microfluidic channel of a microfluidic chip, wherein the excitation light illuminates the fluid for generating fluorescent light;
(c) rejecting out-of-focus light for eliminating unwanted background autofluorescence; and
(d) detecting the fluorescent light.

9. The method of claim 8, wherein spatially filtering the reflected light comprises focusing the reflected emitted light on an opening of a shielding.

10. A microfluidic device for reducing autofluorescence, the microfluidic device comprising:
(a) a polymeric microfluidic chip that encloses a micro scale channel, wherein the microfluidic chip is less than approximately 250 micrometers thick; and
(b) a support frame connected to the microfluidic chip for supporting the microfluidic chip.

11. The microfluidic device of claim 10, wherein the microfluidic chip comprises first and second thin films, wherein the first thin film includes a surface having the microscale channel fabricated therein, and wherein the second thin film is connected to the surface of the first thin film for covering the microscale channel.

12. The microfluidic device of claim 11, wherein the first thin film is less than approximately 125 micrometers thick.

13. The microfluidic device of claim 11, wherein the second thin film is less than approximately 125 micrometers thick.

14. The microfluidic device of claim 10, wherein the support frame comprises a polymer.

15. The microfluidic device of claim 10, wherein the support frame comprises a transparent slide.

16. The microfluidic device of claim 15, wherein the transparent slide comprises glass.

17. The microfluidic device of claim 10, wherein the microfluidic chip includes an upper surface, and wherein the support frame is connected to the perimeter of the upper surface.

18-30. (canceled)

31. A method for reducing autofluorescence in a microfluidic chip, the method comprising:
(a) providing a microfluidic chip including a deep channel;
(b) generating an excitation light;
(c) focusing the excitation light on a fluid inside the deep channel, wherein the excitation light illuminates the fluid for generating fluorescent light; and
(d) detecting the fluorescent light.
